(19) United States
(12) Patent Application Publication
(10) Pub. No.: US 2023/0361329 A1
(43) Pub. Date: Nov. 9, 2023

(54) DUAL-CATHODE FUEL BIOCELL

(71) Applicants: CENTRE NATIONAL DE LA RECHERCHE SCIENTIFIQUE, Paris (FR); INSTITUT POLYTECHNIQUE DE GRENOBLE, Grenoble (FR); UNIVERSITÉ GRENOBLE ALPES, Saint-Martin-D'Here (FR)

(72) Inventors: Michaël HOLZINGER, Saint-Laurent du Pont (FR); Jules HAMMOND, Gières (FR); Andrew GROSS, Saint Martin d'Hères (FR); Jean-Francis BLOCH, Gières (FR); Serge COSNIER, Crolles (FR)

(73) Assignees: CENTRE NATIONAL DE LA RECHERCHE SCIENTIFIQUE, Paris (FR); INSTITUT POLYTECHNIQUE DE GRENOBLE, Grenoble (FR); UNIVERSITÉ GRENOBLE ALPES, Saint-Martin-D'Heres (FR)

(21) Appl. No.: 17/802,658

(22) PCT Filed: Feb. 26, 2021
(86) PCT No.: PCT/EP2021/054882

§ 371 Date: Aug. 26, 2022

(30) Foreign Application Priority Data
Feb. 27, 2020 (FR) FR2001980

(51) Int. Cl. H01M 8/16; H01M 8/1025

(52) U.S. Cl. CPC H01M 8/16; H01M 8/1025; H01M 2008/1095

(57) ABSTRACT

A biocell having an electrochemical cell. The electrochemical cell includes an anode, a first cathode and a second cathode, and first and second porous separator membranes, wherein the first membrane is placed between a first contact surface of the anode and a first surface of the first cathode, and wherein the second membrane is placed between a second contact surface of the anode and a first surface of the second cathode.

### FIELD OF THE INVENTION

The invention relates to an enzymatic fuel cell, or biocell, and to its uses for electricity production, to kits comprising it as well as to electrical or electronic devices incorporating said biocell. The invention also relates to methods of manufacturing this biocell as well as to assemblies comprising at least two biocells according to the invention.

### PRIOR ART

Fuel cell technology is based on the conversion of chemical energy into electronic energy. An organic molecule such as glucose is one of the most important sources of energy for many living organisms and can be considered a safe, easy to handle, and consumable, and therefore biodegradable, biofuel. Biofuel enzyme cells (also called biocells) use enzymes to produce energy or electrical power from biological substrates such as methanol, glucose or starch.

Fuel-powered biocells convert biofuel in the presence of enzymatic compounds, which produces power. The most well-known biocells work by glucose oxidation (GBFC) are such cells which convert glucose by oxidation at the anode for the production of power using an enzyme incorporated therein and having a catalytic function of the reaction. The function of the cathode is generally to reduce oxygen and may or may not include an enzyme that catalyzes this reaction.

Enzymes are promising alternatives to noble metal catalysts, since most of them are operational at neutral pH and at room temperature and offer little or no toxicity, which is not the case with other metal-based catalysts. Biofuel cells therefore offer an attractive means of supplying environmentally friendly and sustainable energy to electronic devices, in particular small portable apparatuses, and/or single-use devices, for applications such as healthcare, environment, biodefense, etc.

Since enzyme-based fuel cells can operate using substrates (like glucose) that are abundant in biological fluids (saliva, blood, urine), of animal or plant origin (fruit juice), etc. as activator and/or fuel. In this context, the terms “fuel” and “biofuel” are interchangeable. In addition, these cells can also make use of environmental effluents (e.g. glucose and oxygen) while exhibiting power densities that are often higher than microbial power densities.

Fuel cells offer an interesting possibility for increasing the power or self-power of portable or implantable miniaturized devices [1, 2, 3]. Additionally, paper- or natural fiber-based devices are gaining popularity as proposals for these types of applications due to their low mass, plasticity and flexibility, allowing them to conform to a full range of different surfaces.

One of the important characteristics of these biocells is a small size (for example, from 1 to 10 cm² of surface area), even very small (less than 0.5 cm² of surface area), to be able to replace the cells of the “button” types frequently used in disposable devices. In addition, they must advantageously have a low mass, and preferably be inexpensive.

Fuel cells offer an interesting possibility for increasing the power or self-power of portable or implantable miniaturized devices [1, 2, 3].

Additionally, paper-based devices are gaining popularity as proposals for these types of applications due to their low mass, low environmental impact, small form factor, and flexibility, which allows them conform to a full range of different surfaces. Such devices are described in particular in application WO2019/234573, the content of which is incorporated by reference in this application.

It is known that the current density at the cathode is one of the limiting factors in the performance of biological fuel cells and this is largely due to the lower concentration of dissolved oxygen available at the interface between the electrode and the solution. It is therefore often advantageous to increase the quantity of oxygen at the surface of the cathode, for example by optimizing its morphology to expose part of the cathode to air [4, 5, 6]. These cathode devices are commonly called “air breathing cathode,” or more simply “air cathode.”

A common strategy to balance the performance of fuel cell electrodes is to increase the size of the electrode. This approach is commonly used for microbial biofuel cells, which require a very bulky anode [8, 9]. More anecdotally, this strategy has also been applied to the cathode of an enzymatic hydrogen biocell [10].

The performance of power sources for portable and/or disposable devices (such as single patient use devices) is often measured in terms of power per unit area (power density (mW·cm⁻²)), power per mass of catalyst (mW·mg⁻¹) or power per catalyst activity (mW·kU⁻¹). These parameters are very difficult to increase.

However, it is extremely desirable to improve the performance of biofuel cells, while avoiding or minimizing the increase in surface area, volume and/or mass of the device, in particular for portable or disposable applications. In this context, a predetermined condition of the area, volume and/or mass of a particular device (or unit) may be referred to as the “footprint” of that device. Of course, this improvement should not increase the cost of the device substantially. Thus, the known solution making it possible to increase the power by a stack of biocells is unsuitable for solving this multifaceted problem. Indeed, it involves a multiplication of the quantity of mediator and of enzyme as well as of the number of electrodes and collectors and a corresponding increase in thickness and costs. The solution consisting in increasing the surface of the cathode leads to an asymmetrical and oversized device. The footprint of the cell is in this case modified in a way that is rarely acceptable for its intended use. Using corrugated electrodes to increase their active surfaces results in increasing the volume of the cell and making it more rigid.

Thus, in general, the invention aims in particular to solve the problem of providing a fuel and gas-powered biocell, in particular of a design allowing use thereof in disposable devices, which is inexpensive (button cell or coin type) and/or designed for single use, preferably of small dimensions, while having optimized power.

The invention in particular aims to increase the supply of gas for the cathodic reaction and allows improved energy production for a given geometric footprint by increasing the oxidant, or substrate (for example the oxygen), at the electrode-solution interface. Advantageously, the lateral footprint of the fuel cell is increased only minimally, or even negligibly. Likewise, only one dimension of the cell can be affected. Thus, it is possible to obtain a cell where only one dimension is increased and/or where the increase in the footprint (for example the increase in thickness) is less than 40%, preferably less than 35% (for example is less than or equal to 30%) with respect to the original dimensions, for example with respect to the thickness. Furthermore, it is also possible, owing to the device according to the invention, to increase the stability of a glucose/O₂ fuel cell by reducing or decreasing, or even eliminating, the consumption of oxygen at the anode. The biocell according to the invention can also produce sufficient power to replace a CR2032-type lithium battery. The invention also aims to increase/maximize the power of a biocell while maintaining the same footprint, and for the same total mass of enzyme.

### DESCRIPTION OF THE INVENTION

An object of the invention is a biocell comprising an electrochemical cell, said electrochemical cell comprising:
an anode consisting of a solid agglomerate having a first contact surface and a second contact surface, said first and second contact surfaces being opposite each other and intended to be brought into contact with a liquid medium, said liquid medium optionally comprising a fuel, said anode comprising a conductive material mixed with a first enzyme capable of catalyzing the oxidation of a fuel and, optionally, mixed with a mediator allowing the transfer of electrons, for example toward an electrode; and
a first cathode and a second cathode each consisting of a solid agglomerate and each having a first contact surface and a second contact surface, said first and second contact surfaces being opposite each other, said first contact surfaces being intended to be brought into contact with a liquid medium and said second contact surfaces being intended to be brought into contact with a gas comprising an oxidant, said first and second cathodes comprising a conductive material, optionally mixed with a second enzyme capable of catalyzing the reduction of said oxidant, and
a first and a second porous separator membrane, each electrically insulating, and permeable to a liquid medium, said first membrane being placed between the first contact surface of the anode and the first surface of the first cathode and said second membrane being placed between the second contact surface of the anode and the first surface of the second cathode;
said biocell further comprises means for electrically switching on said biocell with an electrical receiver, said electric switching means allowing current to flow between the anode and the first and second cathodes. Thus, the electrochemical cell is a dual-cathode cell (comprising one anode and two cathodes) and the biocell that is the object of the invention advantageously comprises a number of cathodes strictly greater than the number of anodes.

The term “biocell” is used in its broadest sense. Thus, “cell” includes, among other things, a device having only one electrochemical cell and/or a device that may or may not be rechargeable. A biocell comprising a stack of several electrochemical cells is envisaged insofar as the cathodes can always be supplied with gas. For example, most electronic devices considered to be powered require a voltage of 1.5 or 3 V. About 3 to 5 biocells, each having a voltage around 0.7 V, connected in series make it possible to obtain this required voltage. An alternative is the use of a voltage converter that can allow the use of a single biocell, reducing the size of the assembly.

Anode and Cathodes

The electrochemical cell comprised in the biocell according to the invention comprises an anode and two cathodes. The anode is positioned between the cathodes. These electrodes are in the form of a solid agglomerate that comprises, at its base, a preferably porous conductive material and at least one enzyme of the half-reaction to be catalyzed. This porous material can be any recyclable porous conductive material, preferably recyclable, such as carbon felt, microporous carbon, carbon nanotubes, activated carbon, mesoporous carbon, carbon black, conductive polymers, etc. In the examples, pellets based on single-walled or more advantageously multi-walled carbon nanotubes (MWCNT), or on carbon black, offer excellent porosity associated with excellent conductivity. By “carbon nanotube” it is meant a carbon nanotube of which at least one dimension is less than 1500 nm. Preferably, the carbon nanotubes have a length (L)/diameter ratio denoted L/diameter of between 100 and 5000. Preferably, the carbon nanotubes have a length of approximately 1.5 μm and for example a diameter of approximately 10 nm.

In the example embodiments of the invention of the application, the fuel chosen is glucose, and the oxidant, oxygen from the air, due to the great availability of these compounds and their low environmental impact. However, the structure of the biocell according to the invention can adapt to substrates other than glucose insofar as the associated enzymatic compounds (enzymes) are also suitable. Thus, the fuel of the biocell according to the invention is advantageously chosen from the group consisting of a sugar (for example: sucrose, glucose, fructose, lactose, etc.), methanol, starch and mixtures thereof. Similarly, the oxidant is not necessarily oxygen and/or oxygen from the air, but may be another gas, for example chosen from the group consisting of carbon dioxide, sulfur, nitrogen oxides and mixtures thereof.

The theoretical reaction balance of the glucose/O₂ enzymatic biocell is as follows:

Anode: glucose→gluconolactone+2H⁺+2e⁻

Cathodes: O₂+4H⁺+4e⁻→2H₂O

Biocell: 2glucose+O₂→2gluconolactone+2H₂O

Thus, according to a preferred aspect of the invention, an enzymatic system used at the anode can comprise at least one glucose oxidase. Glucose oxidases (GOx) are oxidoreductase enzymes of the EC 1.1.3.4 type (April 2018 classification) that catalyze the oxidation of glucose, more particularly β-D-glucose (or dextrose), into hydrogen peroxide and D-glucono-b-lactone, which then hydrolyzes to gluconic acid. Glucose oxidases bind specifically to β-D-glucopyranose (hemiacetal form of glucose) and do not act on α-D-glucose. They are, however, able to act on glucose in its enantiometric forms, because in solution glucose mainly adopts its cyclic form (at pH 7: 36.4% α-D-glucose and 63.6% β-D-glucose, 0.5% in linear form). In addition, the oxidation and consumption of the β form shifts the α-D-glucose/β-D-glucose balance toward this form. The term GOx extends to native proteins and their derivatives, mutants and/or functional equivalents. This term extends in particular to proteins that do not differ substantially in structure and/or in enzymatic activity.

Glucose oxidases comprise and require a cofactor to enable catalysis. This cofactor is Flavin Adenine Dinucleotide (FAD), a major oxidation-reduction component in cells. FAD serves as an initial electron acceptor; it is reduced to FADH₂, which will be re-oxidized to FAD (regeneration) by molecular oxygen (O₂, which is more reducing than FAD). The O₂ is finally reduced to hydrogen peroxide (H₂O₂). The cofactor is comprised in the commercially available GOx enzyme, and the terms GOx and FAD-GOX are equivalent.

The most widely used glucose oxidase is that extracted from Aspergillus niger. However, GOx from other sources can be used, such as for example certain strains of the species Penicillium or of Aspergillus terreus.

Glucose oxidase from Aspergillus niger is a dimer composed of 2 equal subunits with a molecular weight of 80 kDa each (by gel filtration). Each subunit contains a flavin adenine dinucleotide and an iron atom. This glycoprotein contains approximately 16% neutral sugar and 2% amino sugars. It also contains 3 cysteine residues and 8 potential sites for N-glycosylation.

The specific activity of GOx is preferably greater than or equal to 100,000 units/g solid (without addition of O₂). One unit is defined as the oxidation capacity of 1.0 μmole of β-D-glucose to D-gluconolactone and H2O2 per minute at pH 5.1 at 35° C. (Km=33-110 mM; 25° C.; pH 5.5-5.6).

Insofar as the use of GOx involves the production of hydrogen peroxide (harmful species), catalase can be added to the enzymatic system.

Catalase is a tetrameric enzyme catalyzing the reaction: 2H₂O₂→O₂+2 H₂O. Each subunit contains iron bound to a protoheme type IX group. Each subunit is equivalent and comprises a polypeptide chain of approximately 500 amino acids. The molecular weight of each subunit is generally 60 kDa (gel filtration). Catalase can bind strongly to NADP, and NADP and the heme group are then positioned 13.7 Å from each other. It can react with other hydrogenated alkyl peroxides such as methyl peroxide or ethyl peroxide. The activity of catalase is generally constant over a pH range of 4 to 8.5. Its specific activity is preferably greater than 2,000 units/mg, in particular greater than 3,000 units/mg, for example approximately 5,000 units/mg of proteins. One unit is defined as the capacity to decompose 1.0 micromole of hydrogen peroxide (H₂O₂) per minute at pH 7.0 at 25° C., the H₂O₂ concentration preferably falling from 10.3 to 9.2 millimolar. The term “catalase” extends to native proteins and their derivatives, mutants and/or functional equivalents. This term extends in particular to proteins that do not differ substantially in structure and/or in enzymatic activity. The catalase used is preferably of bovine origin.

It is also possible to use other enzymes that transform glucose, and particularly at least one dehydrogenase. In fact, hydrogen peroxide is not produced during the reaction catalyzed by this enzyme, which is advantageous. Dehydrogenases also work in combination with FAD (see above). A particularly preferred dehydrogenase is Flavine Adenine Dinucleotide-Glucose DeHydrogenase (FAD-GDH) (EC 1.1.5.9). The term FAD-GDH extends to native proteins and their derivatives, mutants and/or functional equivalents. This term extends in particular to proteins that do not differ substantially in structure and/or in enzymatic activity. Thus, to produce the anode of the electrochemical cell of the biocell according to the invention, in combination with a cofactor, a GDH enzymatic protein having an amino acid sequence having at least 75%, preferably 95%, and even more preferably 99% identity with the GDH sequence(s) as listed in the databases (for example SWISS PROT), can be used. An FAD-GDH of Aspergillus sp. is particularly preferred and effective, but other FAD-GDHs from Glomerella cingulata (GcGDH), or a recombinant form expressed in Pichia pastoris (rGcGDH), could also be used. The FAD-GDH used in an exemplified embodiment is an FAD-GDH from Aspergillus sp. (SEKISUI DIAGNOSTICS, Lexington, MA, Catalog No. GLDE-70-1192) which has the following characteristics:
Appearance: lyophilized yellow powder.
Activity: >900 U/mg powder 37° C.
Solubility: readily dissolves in water at a concentration of: 10 mg/mL. A unit of activity: quantity of enzyme that will convert one micromole of glucose per minute at 37° C.
Molecular Weight (Gel Filtration) 130 kDa.
Molecular Weight (SDS Page): diffuse 97 kDa band indicative of a glycosylated protein.
Isoelectric point: 4.4.
Kₘ value: 5.10⁻² M (D-Glucose).

The porous conductive material can also comprise an aromatic molecule acting as a redox mediator, such as 1,4-naphthoquinone, to improve electronic exchanges. Other molecules selected from the group formed by 9,10-phenanthroline, 1,10-phenanthroline-5,6-dione, 9,10-anthraquinone, phenanthrene, 1,10-phenanthroline, 5-methyl-1,10-phenanthroline, pyrene, 1-aminopyrene, pyrene-1-butyric acid, and mixtures of two or more of these can also be considered. The use of such compounds proves to be particularly advantageous in the case of enzymatic systems comprising an FAD-GDH or a GOx.

The oxidant of the biocell can advantageously be an oxidizing agent, such as molecular oxygen, and in particular oxygen contained in the air.

When the oxidant is molecular oxygen O₂, the enzymatic system that can be used at the cathodes can advantageously comprise a bilirubin oxidase (BOD), a polyphenol oxidase (PPO) [12] or a laccase (LAC) [13]. For example, BOD is an oxidoreductase enzyme (EC Classification 1.3.3.5, CAS number 80619-01-8; April 2018) that catalyzes the reaction:

2bilirubin+O(2)<=>2biliverdin+2H(2)O.

The most widely used bilirubin oxidase is that extracted from Myrothecium verrucaria. However, the use of BOD from other sources may be considered. The activity of BOD is advantageously greater than 15 units/mg of protein, preferably greater than 50 units/mg, for example around 65 units/mg of protein. One unit is defined as the ability to oxidize 1.0 micromoles of bilirubin per minute at pH 8.4 at 37° C. The term “BOD” extends to native proteins and their derivatives, mutants and/or functional equivalents. This term extends in particular to proteins that do not differ substantially in structure and/or in enzymatic activity.

Protoporphyrin IX (CAS number 553-12-8; April 2018), is a compound with a porphyrinic unit of the crude formula C₃₄H₃₄N₄O₄ [14]. It is used to functionalize the porous conductive material, and in particular the nanotubes, and allow better orientation of enzymes such as BODs. It is therefore advantageously comprised in the material constituting the cathode.

It is immediately understood that the term “enzyme” used here includes enzymatic systems, as described above, which are characterized by a set of molecules and proteins allowing the catalysis of oxidation-reduction reactions that are carried out at the anode and at the cathodes. Thus, optionally, the conductive material is mixed with a promoter (or mediator) facilitating the transfer of electrons, for example toward an electrode.

The solid agglomerate forming the electrodes advantageously combines a porous conductive material and at least one enzyme and/or an enzymatic system and is preferably in the form of a thin film, for example circular or ovoid, but can also be in the form of blocks or thicker pellets. These electrodes are advantageously obtained by compression of the mixture of their constituent elements. The agglomerate can be obtained easily by compression and take any particular shape desired. In particular, the bioanodes and/or biocathodes according to the invention can take the form of small (1 to 2 cm in diameter), or even very small (less than 0.5 cm in diameter), pellets, for example circular or polygonal. Such electrodes can have a thickness varying from 5 mm to 0.1 mm, for example 0.25 mm. As a result, the biocell according to the invention can be of varied shape and of small size. In particular, it can occupy only a volume less than or equal to 2 cm³, preferably less than or equal to 1 cm³, or even less than or equal to 0.75 cm³. It may in particular be designed to be able to replace “button-type” cells.

According to a particularly preferred aspect of the invention, the anode therefore comprises a GOx enzyme, preferably combined with a catalase, or an FAD-GDH enzyme. In this case, the biofuel is therefore glucose. In both cases, the bioanode also comprises a glucose oxidation mediator, for example a 1,4-naphthoquinone compound. Preferably, the biocathodes comprise an enzyme reducing oxygen, and more particularly BOD, advantageously combined with protoporphyrin IX. The terms “biocathode” and “bioanode” refer to the presence of biological material, for example an enzyme, in their structure. In the context of the biocell of the invention, they are to be used in a manner equivalent to the cathodes and the anode.

Electrically Insulating Porous Membrane

The device according to the invention comprises porous separator membranes, electrically insulating, and permeable to the liquid medium, which are placed between the anode on the one hand and the cathodes on the other hand. These membranes, which are advantageously of the same material, allow the passage in particular of ionic species and, advantageously, of substrates between the anode and the cathodes.

According to a particular variant of the invention, said first and, optionally, second membrane are based on cellulose, that is to say, they consist of more than 80%, advantageously more than 95%, by mass of cellulose. They can be a thin sheet (less than 1 mm thick), and in particular a thin sheet of paper, which is of low basis weight (for example less than or equal to 100 g/m². In particular, such a membrane has a thickness of less than 50 μm, preferably less than 500 μm, preferably less than 150 μm of paper, and/or is advantageously biodegradable. Thus, the thickness range of the paper can advantageously be chosen from 900 to 75 μm, preferably from 500 μm to 75 μm, and preferably from 200 μm to 100 μm. The weight of the paper can vary from 300 g/m² to 25 g/m², preferably from 200 g/m² to 50 g/m². More particularly, the paper can be chosen from the group consisting of a paper having a thickness of 0.83 mm and a weight of 291 g/m², 0.42 mm thick and a weight of 183 g/m²g, 0.19 mm thick a weight of 88 g/m², 0.19 mm thick a weight of 90 g/m², 0.16 mm thick a weight of 90 g/m² and 0.35 mm thick a weight of 195 g/m².

According to another preferred variant of the invention, said first and, optionally, second, separating and porous membrane, electrically insulating, and permeable to the liquid medium, is also a means for storing fuel and/or making said liquid available. Advantageously, this storage means is as described above and further comprises fuel, for example a biofuel such as glucose.

Circuitry Means

The biocell according to the invention also comprises electric switching means, which generally incorporate an electrically conductive material. These means can be in the form of layers, tabs, films or wires. Such a layer, tab, film (foil) or wire advantageously has a low thickness, a high thermal and/or electrical conductivity and can comprise, or be (substantially) made of, highly oriented and preferably flexible graphite. Thus, it is possible to use a sheet, or a tab, of pyrolytic graphite (pyrolytic graphite sheet). The use of graphite is advantageous because it combines stability, lightness and electrical and thermal conductivity. Its thickness can be chosen as ranging from 10 to 500 μm, preferably from 17 to 300 μm, and advantageously from 40 to 2,000 μm. It can be chosen from the group consisting of thicknesses of 10, 17, 25, 40, 50, 70, 100 and 200 μm. Its thermal conductivity (in the longitudinal plane of the sheet) may be 100 to 1,000 W/(mK), preferably 100 to 1,950 W/(mK) and advantageously 100 to 1,350 W/(mK). It can be chosen from the group consisting of thermal conductivity values of 200, 400, 700, 1,000, 1,300, 1,350, 1,600, 1,850 and 1,950 W/(mK). This layer may also have an electrical conductivity greater than 5,000 S/cm, preferably greater than or equal to 8,000 S/cm, for example around 10,000 S/cm. However, it may have a higher conductivity, for example around 20,000 S/cm, in particular if the thickness of the layer is less than 40 μm. This layer can also have heat resistance, for example resistance to a temperature of more than 200° C., advantageously of more than 300° C., for example of about 400° C. Such materials can be brought into contact with the anode and the cathodes to allow them to be switched on. Advantageously, as regards the cathodes, an electrically conductive material can comprise, be combined with, or consist of a material that also allows gaseous diffusion at the cathodes. Such a material may comprise, for example, a layer of carbon fiber covered with a layer of carbon black and polytetrafluoroethylene (PTFE). The biocell advantageously comprises terminals (for example, at least one positive terminal and at least one negative terminal) connecting the circuitry means with the exterior of the biofuel cell. Such terminals make it possible to let electric current in or out. These terminals can be a portion of the circuitry means that are dimensioned and positioned in a suitable manner. Thus, these terminals can comprise an extension of a circuitry means (for example, a tab projecting outwards) or can be a portion of the circuitry means made accessible by an opening of a possible external coating. Thus, the circuitry means of said biocell can comprise a conductive element in contact with the anode and a conductive element in contact with the first and the second cathode, said conductive element in contact with the first and the second cathode comprising a material also allowing gaseous diffusion at the cathodes of said oxidant. Preferably, said conductive element in contact with the first and the second cathode comprises two distinct layers, each in contact with an anode.

Support

The biocell according to the invention advantageously comprises an external coating that may be a protective support, layer, or film, which partially covers the electrochemical cell (s) of the device. This is preferably flexible, adhesive, non-toxic, chemically stable, electrically insulating, insensitive to radiation and/or has a wide operating temperature range (for example from −150° C. to 200° C., or even around temperature of 260° C.). This coating, or outer protective film, can comprise, or be (substantially) made of, a glass fiber fabric impregnated with a relatively inert material such as a perfluorinated polymeric material of the PTFE (polytetrafluoroethylene) type or a silicone-based material. The PTFE can be Teflon® from Du Pont de Nemours, Fluon® from Asahi Glass, Hostaflon® from Dyneon. The film or coating is preferably impregnated with more than 50% by weight of said material, advantageously from 50 to 70%, preferably from 57 to 64% relative to the total weight of the film. Its thickness may be a few tenths or even hundredths of a millimeter. For example, it can be chosen from a range of 0.03 to 0.50 mm, preferably 0.05 to 0.30 mm and preferably 0.06 to 0.14 mm, for example be 0.07 mm (NF EN ISO 2286—Dec. 3, 2016). According to a preferred aspect of the invention, the coating, or protective film, comprises an adhesive layer, preferably water resistant, allowing it to adhere to the external surface of the electrochemical cell(s) of the biocell according to the invention. Another material that can be used as an external coating can be of the nonwoven adhesive tape type comprising a layer of synthetic fibers (for example a polyester/rayon blend) and an adhesive layer (for example based on acrylate). This type of material, generally for medical use, is well suited as an external coating.

According to one particular aspect, this protective film can be affixed directly to one face of the cathode, or directly to part of the circuitry means. According to another preferred aspect, this external coating, which is preferably flexible and insulating, comprises one or more openings positioned and dimensioned so as to allow the access of a liquid and/or a gas at the anode and/or the cathode. This opening can be precut in the coating: for example, it can take the form of a series of small circular openings positioned opposite the biocathodes. Additionally or alternatively, this opening can be formed by the fact that the coating does not completely surround the biocell comprising the electrochemical cell(s), but leaves an opening giving access to these elements.

Thus, the biocell according to the invention can advantageously comprise an external coating, preferably flexible, insulating and/or impermeable to liquid, comprising openings positioned and dimensioned so as to allow access of the liquid to the anode and/or of the gas comprising the oxidant to the cathodes.

According to an advantageous aspect of the invention, these openings allow a gas to access each of the cathodes directly or via the circuitry means, which may be the only one.

Structure

According to one aspect of the invention, the electrochemical cell can comprise a series of layers, preferably thin, flexible and/or mechanically robust, forming a preferably self-supporting multilayer (or multi-lamellar) stack. The shape and/or the dimension of these layers, and in particular the presence of at least one opening and/or recess, are advantageously determined so as to constitute, or allow, an electrical connection, an inlet for the fuel and/or an inlet for the oxidant. These layers comprise the anode, the cathodes, the separating layers and the circuitry means, as described in the present application.

According to a particularly preferred aspect, the electrochemical cell according to the invention comprises means for allowing contact between the gas comprising the oxidant and the second surfaces of the cathodes. These means can comprise either a material with a porous structure, as described above, and/or a structure comprising an access path between the second surface of the cathode and a gas source comprising the oxidant.

METHOD and OTHERS

An object of the invention is also a method of manufacturing a biocell as described in the present application. This method comprises positioning and joining the constituent elements of said biocell. This method may comprise using at least one sheet of external coating (or support) as described and comprises the step of positioning, on an internal face, preferably adhesive, of the external coating:
circuitry means,
at least two cathodes surrounding an anode; and
separating, porous and insulating membranes separating the anode from the cathodes.

Preferably, the positioning is a superposition of said elements. The external coating sheet can be dimensioned so that once the elements of the biocell are positioned on the adhesive surface, a free surface is present around the periphery of these elements. This free surface is positioned and sized to allow these elements to be joined together and to constitute the biocell. To perform this step, the sheet can be folded back on itself to cover the other elements of the biocell and/or another coating sheet can be used to cover the elements already positioned on the first coating sheet. These two parts are advantageously joined by the presence of an adhesive on the internal part of the external coating.

The invention also relates to a biocell as described in the present application and further comprising an aqueous liquid, said liquid optionally comprising a biofuel. Indeed, the fuel may already be present in the device in a dry and/or solid and/or non-solubilized form and/or capable of migrating to the enzymatic sites, as described in patent publications FR1855014 and WO2019234573. For example, it can be incorporated into, or positioned near, fuel storage means. When water (pure or not) is added, the fuel thus present (for example sugar) is dissolved in the medium, which allows electrochemical exchanges to take place. Alternatively or additionally, the added liquid comprises the fuel. This can be, for example, a physiological liquid such as blood, urine or saliva or an alcoholic or glucose drink.

An object of the invention is also a method for obtaining a biocell comprising placing a biocell according to the invention as described in the present application in the presence of a liquid, preferably an aqueous liquid, optionally comprising a fuel such as a sugar (for example glucose, fructose, saccharose and/or lactose, etc.), starch or ethanol.

Another object of the invention is an apparatus comprising a biocell according to the invention, and an electrical receiver (that is to say, an apparatus that uses (receives) electric current), said biocell being electrically connected to said electrical receiver. Such an apparatus can be a test, in particular a test of the biological fluid: for example, a pregnancy test or a blood sugar test. Alternatively or additionally, the biocell (and/or the device) according to the invention can be incorporated into an electronic apparatus with electronic display and/or light emission. More generally, the device according to the invention is of the type operating with button-type cells using metallic derivatives, such as a point of care testing (POCT) device, the Internet of Things (I) or a sensor environmental. Such an apparatus according to the invention can advantageously be disposable and/or biodegradable.

Another object of the invention is a kit for the manufacture of a biocell as described in the present application and which comprises a biocell as described in the present application, associated with instructions for use and possibly a container comprising an aqueous liquid as described above.

Another object of the invention is the use of a blotting paper as described above for the manufacture of a biocell or the manufacture of a device for obtaining a biocell according to the invention.

Another object of the invention is the use of a biocell according to the invention for the generation of an electric current.

Another object of the invention an electrochemical cell as described above.

Another object of the invention an electrochemical cell as described above.

### BRIEF DESCRIPTION OF THE FIGURES

The invention will be better understood on reading the description that follows, given solely by way of example and with reference to the appended drawings, in which:

FIG. 1 is a diagram showing the conventional configuration of a single cathode cell (SC) and a single air cathode cell (SABC) as well as the configuration of the dual air cathode cell (DABC) according to the principle of the invention.

FIG. 2 is an exploded front perspective view of the structure of a fuel cell according to the invention.

FIG. 3 is an illustration of the device of FIG. 2 in top view.

FIG. 4 is an illustration of the device of FIG. 2 in top view.

FIG. 5 is a bias diagram showing the peak power for the dual air cathode (DABC) device of FIG. 2.

FIG. 6 is a bias diagram showing the peak power for a single air cathode (SABC) device.

FIG. 7 shows the power curves as a function of the current of the DABC and SABC biocells as well as of a cell comprising two SABCs in series (2×2.5 mg enzymes).

### EXAMPLE EMBODIMENTS

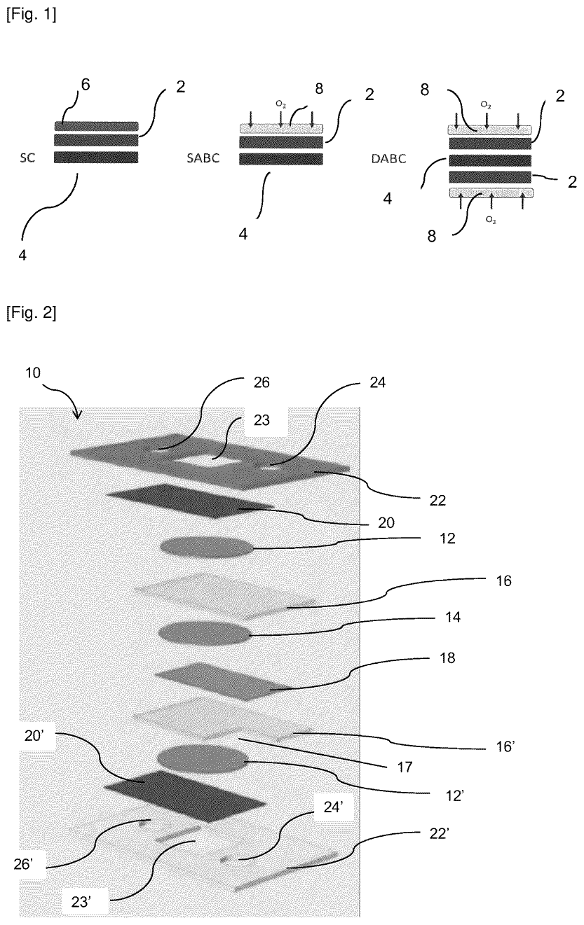

The traditional configuration of a cell (SC) is also shown in FIG. 1. In this figure, the cathode 2 is positioned in a conventional manner between an anode 4 and a support 6. FIG. 1 also shows an air cathode cell (SABC) where the support 8 is permeable to air and allows the penetration of oxygen.

The partial schematic configuration of a cell according to the invention (DABC), for its part, comprises two cathodes 2 positioned on each side of the anode 4. An air-permeable support, or protective layers, 8, is positioned on the external face of each cathode 2. Thus, the surface footprint remains the same while the power density is increased.

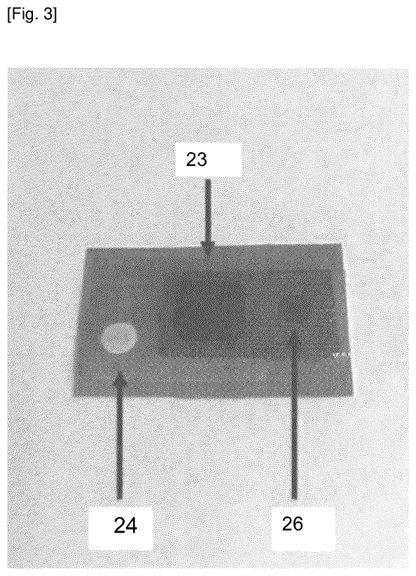

An example of the electrical energy production device has been provided, and its structure is shown in FIG. 2. The device is a fuel cell 10 that comprises a series of layers of constituent materials stacked on top of each other. Obviously, such a device can be positioned during its construction, or its use, in any desired position, and the terms “lower” and “upper” are used only to clarify the relative position of the elements of the device according to the invention in context and in association with the figures.

The cell 10 comprises, as electrodes, an anode 14, an upper cathode 12 and a lower cathode 12′. The electrodes 14, 12 and 12′ are in the form of thin sheets of MWCNT “Multi Walled Carbon Nanotube” nanotubes. Sheets of nanotubes suitable for this use are commercially available or can be easily manufactured using a suspension of nanotubes in a solvent such as DMF, sonication (e.g. 30 minutes) and filtration (PTFE filter from the company Millipore PTFE (JHWP, pore size 0.45 μm, Ø=46 mm). This method is described in detail in Gross et al (2017) “A High Power Buckypaper Biofuel Cell: Exploiting 1,10-Phenanthroline-5,6-dione with FAD-Dependent Dehydrogenase for Catalytically-Powerful Glucose Oxidation” ACS Catal. 2017, 7, 4408-4416. These sheets were modified by depositing (pipette) a solution of the mediator (phenanthrolinequinone, 10 mmol/L in acetonitrile) in an amount of 40 μL/0.785 cm² on each face of the anode 14 and of the promoter (protoporphyrin IX, 10 mmol/L in water) with a volume of 40 μL/0.785 cm² for each cathode 12 and 12′. After drying the electrodes and the mediator, the enzymes are added to these sheets by depositing (pipette) a solution thereof. At the anode 14, a solution of 5 mg/L FAD-GDH is used and a volume of 40 μL/0.785 cm² is deposited on each of the faces of the anode. For the cathodes 12 and 12′, a 5 mg/L Bilirubin oxidase solution is used and a volume of 40 μL/0.785 cm². Each sheet/electrode 12, 12′ and 14 was then left to dry overnight at room temperature.

Liquid diffusion and electrically insulating layers (12×18 mm) are positioned between the anode 14 on the one hand and the cathodes 12 and 12′ on the other hand. The upper diffusion layer 16 is positioned between the anode and the upper cathode 12. The lower diffusion layer 16′ is positioned between the anode 14 and the lower cathode 12′. The diffusion layers are made of Whatman filter paper-type blotting paper. They are cut to meet the configuration of the desired biocell and have a thickness of 190 μm and a weight of 97 g·m⁻². The upper diffusion layer 16 has a different shape from the lower layer 16′. The latter comprises a cutout portion (6×6 mm) in one of its corners, that is to say, a recess 17, which allows access from outside the device 10 to an electrical conductor 18 in contact with the anode 14 and which is positioned between the anode 14 and the diffusion layer 16′.

The electrical conductor 18 consists of a PANASONIC brand flexible graphite sheet sold by the company TOYO TANSO FRANCE SA—ZA du Buisson de la Couldre—9-10 rue Eugene Hénaff—78190 Trappes—France and described in patent JP 3691836. The use of graphite is advantageous because it combines stability, lightness and electrical and thermal conductivity. The electrical conductor sheet 18 measuring (10×18 mm) is positioned between the liquid diffusion layer 16′ and the anode 14 so as to be in direct contact with the latter and partly facing:
1) the recess 17 of the diffusion layer 16′; and
2) the opening 24′ of the support layer 22′.

A conductive and gas diffusion layer 20, also made of carbon, and allowing gas diffusion (here, air) is placed in contact with the upper cathode 12. More particularly, it is placed opposite the face of the cathode 12 that is not in contact with the upper diffusion layer 16. The latter, measuring (10×18 mm), allows the supply of oxygen to the cathode 12. This layer comprises a layer of carbon fiber covered with a layer of carbon black and polytetrafluoroethylene (PTFE) of the SIGRACET® type (marketed by the company SGL CARBON GmbH, Werner-von Siemens Strasse 18, 86405 Meitingen, Germany). The diffusion of the gas is carried out through an opening 23 in particular allowing the passage of the gas toward the cathode 12. A lower conductive and gas diffusion layer 20′ identical to the upper layer 20 is positioned symmetrically and is in contact with the cathode 12′ and facing the opening 23′.

Finally, the cell 12 comprises an upper support sheet, or support, 22, of fiberglass coated with PTFE adhesive (ref. 208AP sold by TECHNIFLON EUROPE, 3, rue du bicentenaire de la Révolution, 91220 LE PLESSIS PATE, FR). The upper support 22 measures 18×28 mm and comprises a central opening 23 measuring 8×8 mm and two circular openings 24 and 26 measuring 4 mm in diameter. The support sheet 22 covers the upper conductive and gas diffusion layer 20. The circular opening 24 allows access of a liquid to the elements of the cell. A lower support sheet 22′ forms the underside of the cell and may be of the same composition and size as the upper support sheet 22. In this example, however, the sheet 22 is a sheet of the non-woven adhesive tape type comprising a layer of polyester/rayon fibers and an acrylate-based pressure-sensitive adhesive layer sold by the company 3M. This type of material, generally for medical use, is well suited as an external coating.

The support 22′ comprises a central opening 23′ and first and second circular openings 24′ and 26′. This support 22′ is positioned so as to cover the lower conductive and gas diffusion layer 20′. The adhesive surface of the sheets 22 and 22′ facing each other and in view of their larger dimensions than the other elements of the cell 10, the edges of the sheets 22 and 22′ can come into contact and join securely.

Thus, the cathodes 12 and 12′ as well as their respective electrical contacts are located on both sides of the anode 14 and can be physically or electronically connected to each other.

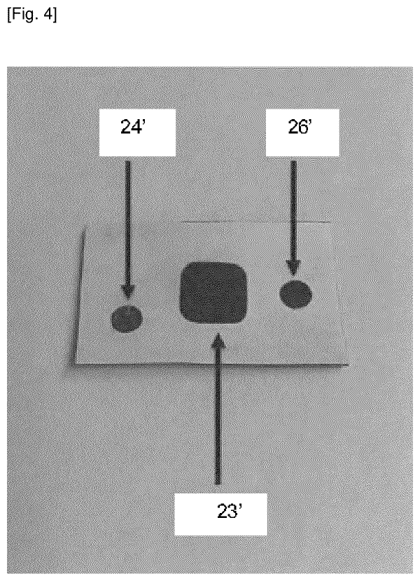

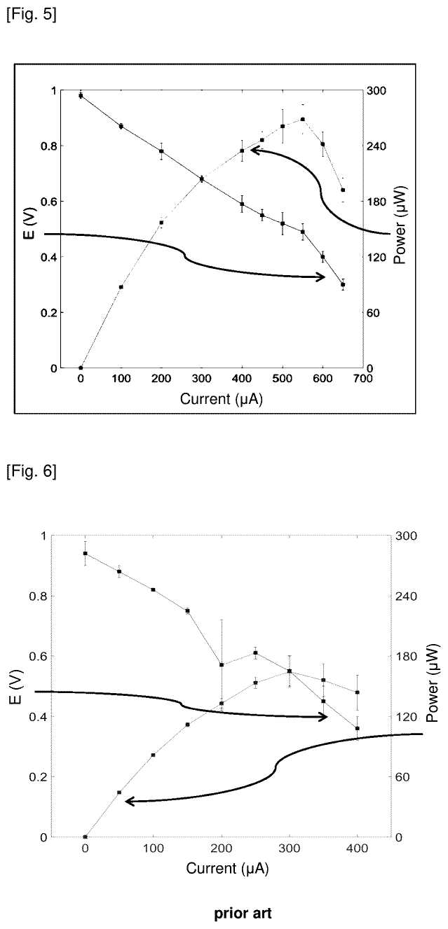

To generate electricity, a phosphate-buffered saline solution, pH 7.4 at 20° C.) comprising 170 mmol of glucose was poured onto the upper diffusion layer 20 via the opening 24 (cf. FIG. 3) using a pipette. By capillarity, the liquid propagates in the device 12 and reaches the liquid diffusion layers and 16′, which allows the ionic exchange of protons between the cathodes 12 and 12′ and the anode 14 and therefore the production of current at the biocell terminals 10. As is apparent from FIGS. 3 and 4, these terminals are constituted by the part of the electrical conductor 18 that is accessible through the opening 24′, for the anode, and by the parts of the conductive and gas diffusion layers 20 and 20′ accessible through openings 26 and 26′, respectively. The bias diagram of the DABC device according to the invention is shown in FIG. 5. The air containing the oxidant (oxygen) reaches the cathodes through the central openings 23 and 23′.

To compare the efficiency of the device 10 according to the invention, a single air cathode device SABC was produced. This device differed from that of the invention only in that it does not comprise a lower cathode 12′ or a lower conductive and diffusion layer 20′. The SABC device was the same size as the device according to the invention previously described, and contained the same total mass of enzyme, mediator, glucose, buffered saline solution and insulator/transport layers. In the case of the SABC device, the enzyme mass was distributed on a single cathode (instead of two) and on a single face of the anode (instead of two). The thickness of the liquid diffusion layer was exactly twice that used in the device according to the invention.

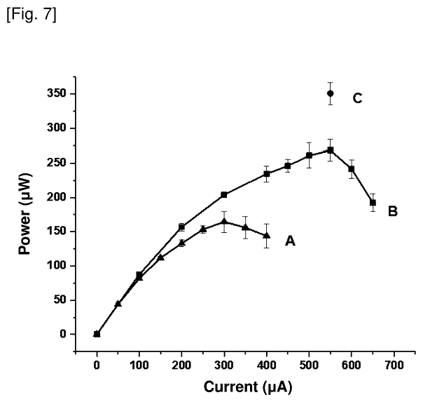

The bias diagram of the SABC device was made is shown in FIG. 6.

These diagrams were obtained by measuring the open circuit voltage (OCV) after applying a constant discharge current for a period of 60 s. The value of the discharge current was constantly increased until the maximum power was determined and then until this power collapsed.

The power peak of the DABC device according to the invention is 63% higher than that of the SABC device. Peak operational power appears to occur over a slightly wider current range, suggesting that DABC devices may perform better over a wide range of discharge currents.

The optimum amount of enzyme at the cathode (BOD) for the devices tested is 2.5 mg/cm².

Finally, the power curves according to the current of the devices
SABC (curve A single cathode (2.5 mg enzymes/cm²)) and
DABC (curve B—a double cathode according to the invention (2×1.25 mg enzymes/cm²));

have been plotted on the diagram of FIG. 7 as well as point C), which corresponds to the power of a biocell at 550 μA comprising two SABCs connected in series (2.5 mg/cm² enzymes). Such a DABC cell allows a power 30% higher than that of the invention, but requires twice as many enzymes at the cathode.

With the same amount of enzymes, a potency increase of about 70% was obtained. With the device according to the invention. Such an increase was not foreseeable.

The invention is not limited to the embodiments described here, and other embodiments will become clearly apparent to a person skilled in the art.

It is of course possible to provide for the use of materials different from those mentioned above to form the various elements forming the device for producing electrical energy. The compounds making it possible to produce energy can also be different from those mentioned above, as well as the arrangement of the various elements (anode, cathodes, conduction and/or diffusion layers, terminals, etc.) with respect to each other.

### LIST OF REFERENCE NUMBERS

2: cathode.
4: anode.
6: support.
8: gas permeable support.
10: gas breathing enzymatic fuel cell.
12: upper cathode of cell 10.
12′: lower cathode of cell 10.
14: anode of cell 10.
16: upper electrically insulating liquid diffusion layer of cell 10.
16′: lower electrically insulating liquid diffusion layer of cell 10.
17: recess of layer 16′.
18: electrical conductor of cell 10.
20: upper conductive and gas diffusion layer of cell 10.
20′: lower conductive and gas diffusion layer of cell 10.
22: upper support sheet, or support, of cell 10.
22′: bottom support sheet, or support, of cell 10.
23: central opening of support 22.
23′: central opening of support 22′.
24: first circular opening of support 22 allowing the introduction of a liquid into the cell and the diffusion layers 16 and 16′
24′: first circular opening of support 22′ for electrical contact (toward anode 14)
26: second circular opening of support 22 for electrical contact (toward cathode 12′)
26′: second circular opening of support 22′ for electrical contact (toward cathode 12).

### LIST OF DOCUMENTARY REFERENCES

1. P Atanassov, M. Y El-naggar, S. Cosnier and U. Schröder, Chem Electro Chem, 2014, 1, 1702-1704.
2. E. Katz and K. MacVittic, Energy Environ. Sci., 2013, 6, 2791.
3. S. Cosnier, A. J. Gross, A. Le Goff and M. Holzinger, J. Power Sources, 2016, 325, 252-263.
4. P. Maan Kumar and A. K. Kolar, Int. J. Hydrogen Energy, 2010, 35, 671-681.
5. Ferreira-Aparicio and A. M. Chaparro, Int. J. Hydrogen Energy, 2014, 39, 3997-4004.
6. Z. Xiong, S. Liao, S. Hou, H. Zou, D. Bang, X. Tian, H. Nan, T Shu and L. Du, Int. J. Hydrogen Energy, 2016, 41, 9191-9196.
7. S. Sibbett, C. Lau, G. P. M. K. Cinciato, P. Atanassov, Paper-Based Fuel Cell, U.S. Pat. No. 9,257,709B2, 2016.
8. Susanto, M. Baskoro, S. H Wisudo, M. Riyanto, F Purwangka, International Journal of Renewable Energy Research, 7(2017) 298-303.
9. Ueoka, N. Sese, M. Sue, A. Kouzuma, K. Watanabe, Journal of Sustainable Bioenergy Systems, 2016, 6, 10-5.
10. N. Plumeré, O. Rüdiger, A. A. Oughli, R. Williams, J. Vivekananthan, S. Pöller, et al., Nat. Chem., 2014, 6, 822-7.
11. R. D. Milton, F Giroud, A. E. Thumser, SD. Minteer, R. C. T Slade Phys. Chem. Phys., 2013, 15, 19371-19379.
12. B. Reuillard, A. Le Goff, C. Agnès, A. Zebda, M. Holzinger, S. Cosnier, “Direct electron transfer between tyrosinase and multi-walled carbon nanotubes for bioelectrocatalytic oxygen reduction” Electrochem. Commun. 2012, 20, 19. (doi: 10.1016/j.elecom.2012.03.045).
13. Lalaoui, N.; David, R.; Jamet, H.; Holzinger, M.; Le Goff, A.; Cosnier, S., “Hosting Adamantane in the Substrate Pocket of Laccase: Direct Bioelectrocatalytic Reduction of O₂ on Functionalized Carbon Nanotubes”. ACS Catalysis 2016, 4259-4264. (DOI: 10.1021/acscatal.6b00797.
14. A. J. Gross, X. Chen, F Giroud, C. Abreu, A. Le Goff, M. Holzinger, S. Cosnier “A High Power Buckypaper Biofuel Cell: Exploiting 1,10-Phenanthroline-5,6-dione with FAD-Dependent Dehydrogenase for Catalytically-Powerful Glucose Oxidation” ACS Catal. 2017, 7, 4408-4416.

1-10. (canceled)

11. A comprising an electrochemical cell, said electrochemical cell comprising:
an anode consisting of a solid agglomerate having a first contact surface and a second contact surface, said first and second contact surfaces being opposite each other and intended to be brought into contact with a liquid medium, said liquid medium optionally comprising a fuel, said anode comprising a conductive material mixed with a first enzyme capable of catalyzing the oxidation of a fuel and, optionally, a mediator allowing the transfer of electrons;
a first cathode and a second cathode each consisting of a solid agglomerate and each having a first contact surface and a second contact surface, said first and second contact surfaces being opposite each other, said first contact surfaces being intended to be brought into contact with a liquid medium and said second contact surfaces being intended to be brought into contact with a gas comprising an oxidant, said first and second cathodes comprising a conductive material, optionally mixed with a second enzyme capable of catalyzing the reduction of said oxidant; and
a first and a second porous separator membrane, each electrically insulating, and permeable to a liquid medium, said first membrane being placed between the first contact surface of the anode and the first surface of the first cathode and said second membrane being placed between the second contact surface of the anode and the first surface of the second cathode;
said biocell further comprising means for electrically switching on said biocell with an electrical receiver, said electric switching means allowing current to flow between the anode and the first and second cathodes.

12. The biocell according to claim 11, wherein said electrochemical cell comprises a series of layers, forming a multilayer stack, these layers comprising said anode, cathodes, separator layers and circuitry means.

13. The biocell according to claim 11, wherein said fuel is selected from the group consisting of sugar, methanol, starch and mixtures thereof.

14. The biocell according to claim 11, wherein the oxidant is selected from the group consisting of carbon dioxide, sulfur or nitrogen oxides and mixtures thereof.

15. The biocell according to claim 11, wherein said first and, optionally, second membranes are based on cellulose.

16. The biocell according to claim 11, wherein said circuitry means comprise a conductive element in contact with the anode and a conductive element in contact with the first and the second cathode, said conductive element in contact with the first and the second cathode comprising a material also allowing gaseous diffusion at the cathodes of said oxidant.

17. The biocell according to claim 11, wherein said separating and porous membranes, electrically insulating, and permeable to the liquid medium, are also a means for storing said fuel and making the liquid available.

18. The biocell according to claim 11, wherein said biocell comprises an external coating, preferably flexible, insulating and/or impermeable to liquid, comprising openings positioned and dimensioned so as to allow access of said liquid to the anode and/or of said gas to the cathodes.

19. An apparatus comprising the biocell according to claim 11, and an electrical receiver, said biocell being electrically connected to said electrical receiver.

20. A method of generating a current, comprising:
electrically switching on the biocell according to claim 11 or an apparatus comprising the biocell and an electrical receiver, said biocell of said apparatus being electrically connected to said electrical receiver.
